(19) United States
(12) Patent Application Publication
(10) Pub. No.: US 2005/0247682 A1
(43) Pub. Date: Nov. 10, 2005

(54) Laser beam machine

(76) Inventors: Tadashi Kuroiwa, Tokyo (JP); Kenichi Ijima, Tokyo (JP); Nobutaka Kobayashi, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/524,241

(22) PCT Filed: May 19, 2004
(86) PCT No.: PCT/JP04/07129

§ 371 Date: Feb. 10, 2005

(30) Foreign Application Priority Data
May 19, 2003 (JP) 2003-139962

(51) Int. Cl. B23K 26/06

(52) U.S. Cl. 219/121.73

(57) ABSTRACT

In a laser machining apparatus for machining a workpiece (13), a laser (2) emitted from an oscillator (1) is dispersed into a first laser beam (7) that is passed through a first polarizing means (6) and is reflected, via a mirror (5), by a second polarizing means (9), and a second laser beam (8) that is reflected by the first polarizing means (6), is scanned bi-axially by a first galvano-scanner (11), and is passed through the second polarizing means (9); scanning by a second galvano-scanner (12) is carried out, and a third polarizing means (15) for polarizing angle adjustment, capable of angle adjustment, is disposed before the first polarizing means (6).

### TECHNICAL FIELD

The present invention relates to laser machining apparatuses primarily intended for machining and drilling workpieces such as printed circuit boards and the like, a laser from one laser light source being dispersed into a plurality of beams, so that productivity and machining quality are improved.

### BACKGROUND ART

A laser passed through a mask is dispersed via a half-mirror into a plurality of laser beams, each of the plurality of dispersed laser beams is guided to a plurality of galvano-scanner systems disposed on the incident side of an fθ lens, and by scanning by means of the plurality of galvano-scanner systems, it is possible to irradiate a partitioned machining area. A dispersed laser beam is introduced, via a first galvano-scanner system, to half the area of the fθ lens.

Further, another dispersed laser beam is introduced via a second galvano-scanner system to the remaining half of the area of the fθ lens, and by disposing the first and the second galvano-scanner systems symmetrically with respect to the center axis of the fθ lens, each half of the fθ lens is used simultaneously and it is possible to improve productivity. (Refer to patent reference 1.)

Patent Reference 1: Japanese Laid-Open Patent Publication 1999-314188 (page 3, FIG. 1.)

A conventional laser machining apparatus has a configuration in which the laser beam is dispersed, via the half-mirror, into the plurality of beams, two of which are each scanned by the first galvano-scanner system and by the second galvano-scanner system, and are irradiated onto the partitioned machining area, so that due to the difference between the two laser beams dispersed by the half-mirror-namely the difference due to being reflected and being transmitted by the half-mirror-variation in quality of the laser beams occurs easily, and, in cases where the energy of the laser beams ends up being different, additional expensive optical members are necessary in order to equalize the energy.

Furthermore, after the two dispersed laser beams have passed through the mask and up to when they irradiate the workpiece, the light path lengths are different, and there has been a problem in that precise beam spot diameters on the workpiece end up being different.

Additionally, in order to divide equally with the fθ lens, and simultaneously machine the partitioned machining areas, when there is a large difference in the number of holes to be drilled in the machining areas, or when there are no holes to be drilled in either of the machining areas, such as in the marginal section of the work or similar situations, improvements in productivity cannot be expected.

### DISCLOSURE OF INVENTION

The present invention has been made to solve such problems and has as an object the provision of a laser machining apparatus that improves productivity at lower cost by minimizing differences in energy and quality of dispersed laser beams, by being able to produce a uniform beam spot diameter by making the light path lengths of each of the laser beams the same, and by irradiating the dispersed laser beams on the same area.

A further object is the provision of a laser machining apparatus that, by a simple adjustment, can even the differences in the energy and focal position of the dispersed laser beams and enable more stable machining performance.

In order to realize these objects, in a laser machining apparatus for machining a workpiece, a laser emitted from an oscillator is dispersed into a first laser beam that is passed through a first polarizing means and is reflected, via a mirror, by a second polarizing means, and a second laser beam that is reflected by the first polarizing means, is scanned bi-axially by a first galvano-scanner, and is passed through the second polarizing means; the beams are scanned by a second galvano-scanner, and before the first polarizing means, a third polarizing means for polarizing angle adjustment that can adjust the angle is disposed.

Further, in a laser machining apparatus for machining a workpiece, a laser emitted from an oscillator is dispersed into a first laser beam that is passed through a first polarizing means and is reflected, via a mirror, by a second polarizing means, and a second laser beam that is reflected by the first polarizing means, is scanned bi-axially by a first galvano-scanner, and is passed through the second polarizing means; the beams are scanned by a second galvano-scanner, and, based on a measuring means for measuring the focal position of the laser, the focal positions of the two laser beams are measured, and, by means of a focal position adjusting means carries out adjustments so that the difference between the focal positions of the two laser beams is below a desired standard.

### BRIEF DESCRIPTION OF DRAWINGS

FIG. 1 is a schematic configuration diagram of a laser machining device in accordance with Embodiment 1 of this invention;

FIG. 2 is a dispersion pattern diagram for a polarizing beam splitter;

FIG. 3 is a schematic configuration diagram of a laser machining device in accordance with Embodiment 2 of this invention;

FIG. 4 is an enlarged diagram of members of the polarizing beam splitter for polarizing angle adjustment;

FIG. 5 is a flow diagram for an automatic adjustment program for the polarizing beam splitter for polarizing angle adjustment;

FIG. 6 is a schematic configuration diagram of a laser machining device in accordance with Embodiment 3 of this invention;

FIG. 7 is a schematic diagram illustrating changes in focal position for the laser machining device in accordance with Embodiment 3 of this invention;

FIG. 8 is a schematic configuration diagram of a laser machining device in accordance with Embodiment 4 of this invention;

FIG. 9 is a schematic diagram illustrating changes in focal position for the laser machining device in accordance with Embodiment 4 of this invention;

FIG. 10 is a pattern diagram illustrating changes in laser beam polarized direction for a laser machining device in accordance with Embodiment 4 of this invention; and

FIG. 11 is a flow diagram for a program for automatic adjustment of focal position by a focal position varying means.

### BEST MODE FOR CARRYING OUT THE INVENTION

### Embodiment 1

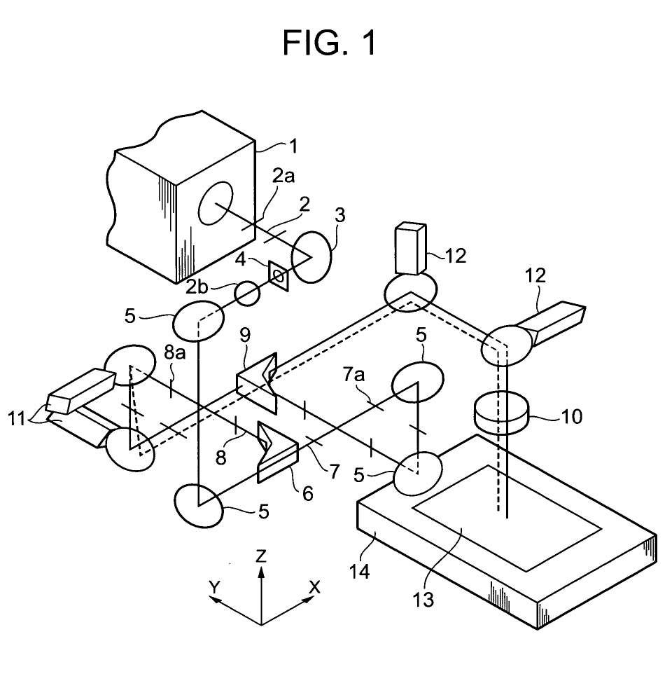

FIG. 1 is a schematic configuration diagram illustrating a laser machining apparatus for drilling wherein, by dispersing one laser beam into two laser beams by a polarizing beam splitter for dispersion, and by scanning the two laser beams independently, machining of two positions can be implemented simultaneously.

In the figure, reference numeral 1 denotes a laser oscillator, reference numeral 2 denotes a laser beam, reference numeral 2a denotes the polarized direction of the laser beam 2 before it is irradiated on a retarder 3, reference numeral 2b denotes the polarized direction of the laser beam 2 after it is reflected by the retarder 3, reference numeral 3 denotes the retarder for changing the linear polarized laser beam into a circular polarized beam, reference numeral 4 denotes a mask for removing unnecessary proportions of the incident laser beam in order to have a desired size and shape for a hole to be drilled, reference numeral 5 denotes a plurality of mirrors for reflecting the laser beam 2 and guiding it along a light path, reference numeral 6 denotes a first polarizing beam splitter for dispersing the laser beam 2 into two laser beams, reference numeral 7 denotes one of the laser beams dispersed by the first polarizing beam splitter 6, reference numeral 7a denotes the polarized direction of the laser beam 7, reference numeral 8 denotes the other of laser beams dispersed by the first polarizing beam splitter, reference numeral 8a denotes the polarized direction of the laser beam 8, reference numeral 9 denotes a second polarizing beam splitter for guiding the laser beam 7 and the laser beam 8 to a galvano-scanner 12, reference numeral 10 denotes an fθ lens for focusing the laser beams 7 and 8 onto a workpiece 13, reference numeral 11 denotes a first galvano-scanner for bi-axially scanning the laser beam 8 and guiding it to the second polarizing beam splitter, reference numeral 12 denotes the second galvano-scanner for bi-axially scanning the laser beam 7 and the laser beam 8 and guiding them to a workpiece 13, reference numeral 13 denotes the workpiece, reference numeral 14 denotes an X-Y stage for moving the workpiece 13.

Furthermore, the configuration is such that the light path lengths of each of the laser beams 7 and 8, which are dispersed by the first polarizing beam splitter 6, up to where they reach the second polarizing beam splitter 8, have the same light path lengths.

Detailed operations for this embodiment are explained below. As illustrated in this embodiment, in the laser machining apparatus for drilling, by dispersing one laser beam into the two laser beams by means of the polarizing beam splitter for dispersing, and by independently scanning the two laser beams, it is possible to implement machining of two positions at the same time, wherein the laser beam 2, oscillated by the laser oscillator 1 into liner polarized light, is converted into circular polarized light by the retarder 3 disposed along the light path, and is guided via the mask 4 and the mirrors 5 to the first polarizing beam splitter 6.

Regarding the laser beam 2, irradiated as circular polarized light to the first polarizing beam splitter 6, P-wave components pass through the polarizing beam splitter 6 and form the laser beam 7, and S-wave (Senkrecht-wave) components are reflected by the polarizing beam splitter 6 and are dispersed into the laser beam 8.

Furthermore, since the circular polarized light uniformly contains elements polarized in all directions, it is dispersed so that the laser beam 7 and the laser beam 8 have the same energy.

The laser beam 7 that passes through the first polarizing beam splitter 6 is guided, via bending mirrors 5, to the second polarizing beam splitter 9.

Meanwhile, the laser beam 8 that is reflected by the first beam splitter 6, after being scanned bi-axially by the first galvano-scanner 11, is guided to the second polarizing beam splitter 9.

The laser beam 7 is always guided to the same position by the second polarizing beam splitter 9; however, for the laser beam 8, incident position and angle to the second polarizing beam splitter 9 can be adjusted by controlling the bending angle of the first galvano-scanner 11.

Then, after the laser beams 7 and 8 are scanned bi-axially by the second galvano-scanner 12, they are guided to the fθ lens and each of them is focused onto prescribed positions on the workpiece.

At this time, by scanning with the first galvano-scanner 11, it is possible to irradiate the laser beam 8 onto the same position on the workpiece 13 as the laser beam 7.

Furthermore, within a predetermined area, by scanning the laser beam 8, by means of the galvano-scanner 11, onto an arbitrary position with respect to the laser beam 7, for example, considering the characteristics of the beam splitter optical elements, inside a 4 mm square area on which the laser beam 7 is centered, and, for example, by means of the second galvano-scanner 12 that can scan within a machinable area of 50 square mm or similar, it is possible to irradiate the laser beams onto two different arbitrary points on the workpiece 13.

This embodiment is configured so that the laser beam 8 that is reflected by the first polarizing beam splitter 6 passes through the second polarizing beam splitter 9, and the laser beam 7 that passes through the first polarizing beam splitter 6 is reflected by the second polarizing beam splitter 9.

As a result, since the two dispersed laser beams each go through a process of being reflected and being passed through, it is possible to cancel out quality variations and loss of energy balance in the laser beams due to differences between reflection and passing through.

Here, the quality of machined holes, drilled by the laser beam 7 and the laser beam 8 in the workpiece 13 depend greatly on the energy of the laser beams.

In order to drill holes of the same quality in the workpiece 13 with the laser beam 7 and the laser beam 8, it is necessary to have the energy of the laser beam 7 and the laser beam 8 the same. Thus, this embodiment disperses a beam into two laser beams, using the first polarizing beam splitter 6 to disperse the laser 2 into the laser beam 7 and the laser beam 8, passing the P-waves (Parallel-waves) through and reflecting the S-waves.

For the first polarizing beam splitter 6, it is necessary that the incident laser beams have uniform P-wave and S-wave components.

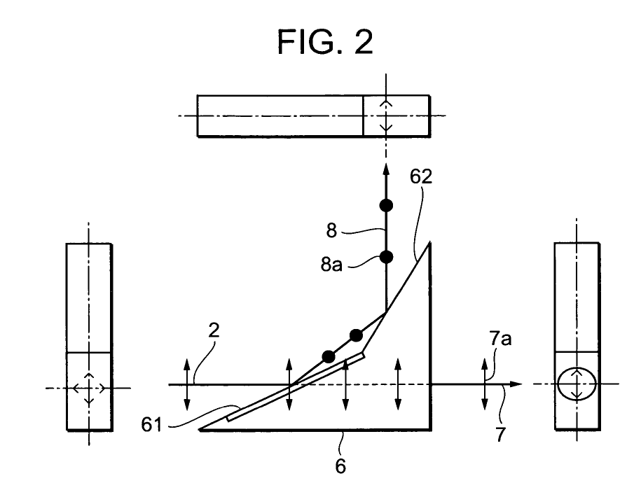

FIG. 2 illustrates, in the center, a front view of the first polarizing beam splitter 6; side views thereof are illustrated on the left and right sides, and an upper view thereof, on the top.

In the figure, reference numeral 61 denotes an optical member of the polarizing beam splitter, in which, for carbon dioxide lasers, ZnSe or Ge is used.

Reference numeral 62 denotes a mirror for turning the laser beam through 90 degrees.

The laser beam incident on the polarizing beam splitter 6 has characteristics such that its components in the polarized direction 7a (P-wave components) are passed through, and its components in the polarized direction 8a (S-wave components) are reflected.

In this regard, the polarized directions of the P-waves and the S-waves are orthogonal to each other.

Thus, when the polarized direction of the incident laser is the same as polarized direction 7a (the P-wave components) all of it is passed through, and when the same as polarized direction 8a (the S-wave components) all of it is reflected.

Further, for circular polarized light in which all polarized directions are uniform, and for polarized directions that are at angles of 45 degrees to the P-waves and the S-waves, the laser beams are evenly dispersed and the energy of the laser beam 7 and the laser beam 8 is the same.

In this embodiment, by disposing the two polarizing beam splitters as illustrated in FIG. 1, since the light path lengths of the laser beams 8 and 7 between the first polarizing beam splitter 6 and the second polarizing beam splitter 9 are identical, it is possible to make the beam spot diameter of the two dispersed laser beams identical.

For example, in the embodiment of the present invention, even if the light paths are decomposed into X, Y and Z directions, each has an identical light path length, so that even with large or small design changes in the light path configuration elements, it is possible to extend or contract the light paths in the X, Y and Z directions, and to keep the light path lengths of the laser beams 8 and 7 the same.

### Embodiment 2

In the above described Embodiment 1, it is necessary to irradiate the laser beam 2, amplified by the laser oscillator 1, such that the incident light and the reflected light are at 90 degree angles on the retarder 3, and it is necessary that the light beam 2 is incident such that a polarizing orientation 2a thereof is at an angle of 45 degrees to the intersection line of a reflection plane of the retarder 3 and a two-sided plane formed of the incident light axis and the reflected light axis with respect to the retarder 3.

Here, supposing that adjustment of the beam axis angle and the polarized direction of the incident polarizing beam 2 with respect to the retarder 3 are insufficient, the circular polarized light rate degrades, and the balance is lost for the P-wave components and the S-wave components of the laser beam 2 incident on the first polarizing beam splitter 6, so that the energy of the laser beam 7 and the laser beam 8 is no longer uniform, and since with adjustments of the beam axis angle and the polarized direction of the laser beam 2 when incident on the retarder 3, the polarized direction cannot be seen with the eye and the beam cannot be seen as in carbon dioxide lasers, so that the beam axis angle cannot be seen, the circular polarized light rate is measured, and if it is insufficient, angle adjustment must be repeatedly implemented, resulting in cumbersome tasks.

Moreover, after the laser beam 2 is made into the circular polarized beam 2b, it is reflected by a plurality of mirrors 5 up until it irradiates the first polarizing beam splitter 6; however, when reflected by the mirrors 5, the circular polarized light rate may degrade.

Thus, in this embodiment, circular polarized light is not used, and an explanation is given of cases using laser beams amplified with linear polarization.

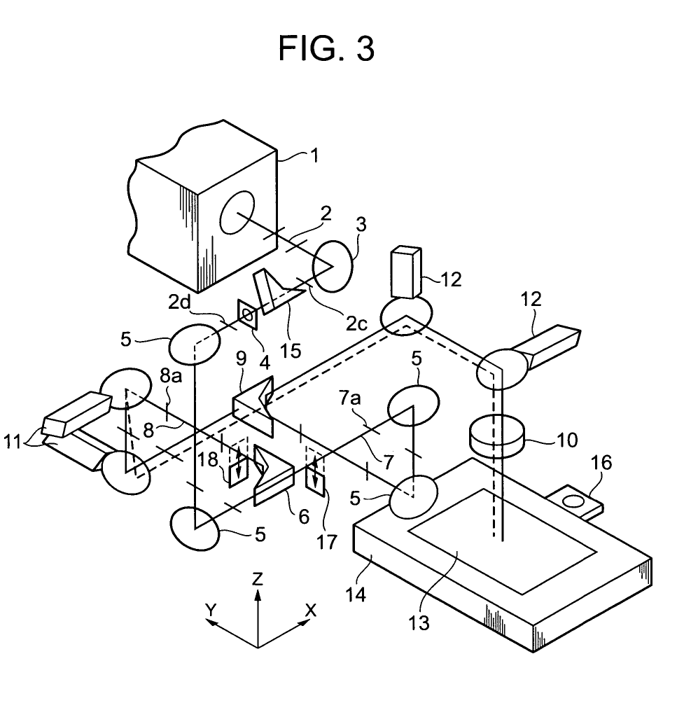

FIG. 3 is a schematic configuration diagram illustrating the laser machining apparatus in accordance with this embodiment of the invention.

In the figure, reference numeral 2c denotes the polarized direction of the laser beam 2 before it irradiates a third polarizing beam splitter 15, reference numeral 2d denotes the polarized direction of the laser beam 2 after it passes through the third polarizing beam splitter 15, reference numeral 15 denotes the third polarizing beam splitter for adjusting the polarized direction of the laser beam 2, reference numeral 16 denotes a power sensor for measuring the energy of the laser beams emitted from the fθ lens 10, reference numeral 17 denotes a first shutter for cutting off the laser beam 7, and reference numeral 18 denotes a second shutter for cutting off the laser beam 8.

The power sensor 16 is fixed to the XY table 14; when measuring the energy of the laser beams, the power sensor 16 can move to a position at which laser light falls on a light receptor of the power sensor 16.

Other similar reference numerals are the same as in FIG. 1 illustrating Embodiment 1, and are omitted.

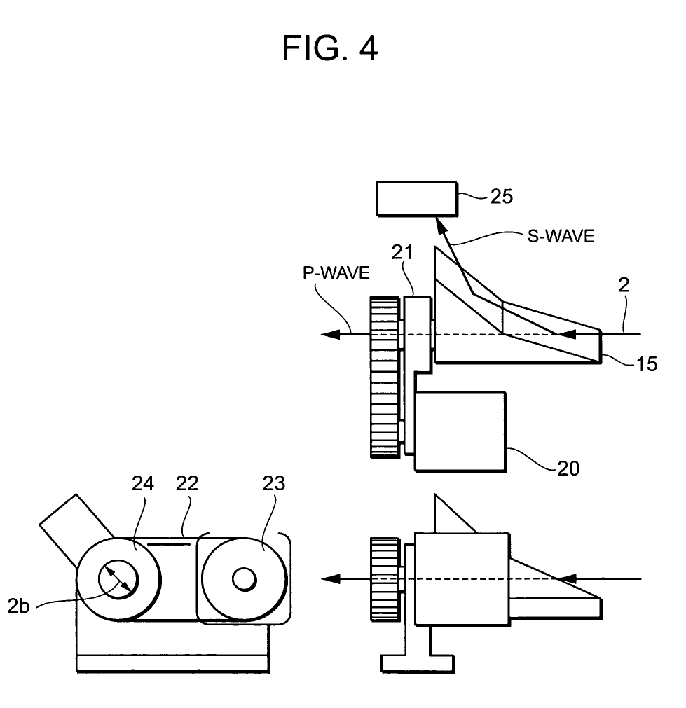

FIG. 4 is a detailed diagram of the third polarizing beam splitter 15 illustrated in FIG. 3.

In the figure, reference numeral 20 denotes a servo motor, reference numeral 21 denotes a bracket for fixing the third polarizing beam splitter 15 and the servo motor 20, reference numeral 22 denotes a timing belt for communicating power from the servo motor 20 to the third polarizing beam splitter 15, reference numeral 23 denotes a first pulley, attached to the servo motor 20, for communicating the power of the servo motor 20 to the timing belt 22, reference numeral 24 denotes a second pulley, attached to the third polarizing beam splitter 15, that is revolved by the timing belt 22, and reference numeral 25 denotes a damper for stopping the S-wave components of the laser beam 2 reflected by the third polarizing beam splitter 15.

The laser beam 2, amplified by the laser oscillator 1 into the linear polarized beam 2c, is reflected by the mirrors 5 and is guided to the third polarizing beam splitter 15.

The P-wave components of the laser beam 2 are passed through the third polarizing beam splitter 15—the polarized direction being changed to a linear polarized beam 2d at an angle different to the linear polarized beam 2c—and are guided to the mask 4.

Further, the S-wave components of the laser beam 2 are reflected by the third polarizing beam splitter 15 and absorbed by the damper 25.

Only the desired portion of the laser beam 2 is passed through the mask 4, reflected by the mirrors 5, and guided to the first polarizing beam splitter 6.

In the first polarizing beam splitter 6, the P-wave components of the laser beam pass through the first polarizing beam splitter 6 (the laser beam 7), and the S-wave components are reflected by the first polarizing beam splitter 6 (the laser beam 8).

The laser beam 7, after being reflected by the mirrors 5 and guided to the second polarizing beam splitter 9, is guided to the second galvano-scanner 12, is scanned in the X-direction and the Y-direction, is focused by the fθ lens 10, and machines the workpiece 13 loaded on the XY-table 14.

Laser beam 8, on the other had, is scanned in the X-direction and the Y-direction by the first galvano-scanner 11 and is guided to the second polarizing beam splitter 9.

Then, after being scanned by the second galvano-scanner 12 again in the X-direction and the Y-direction, it is focused by the fθ lens 10 and machines the workpiece 13 loaded on the XY-table 14.

In order to change the energy balance of the laser beam 7 and the laser beam 8, the proportions of the P-wave components and the S-wave components incident on the first polarizing beam splitter 6 may be changed, and for cases where linear polarized laser beams are irradiated on the first polarizing beam splitter 6, the polarizing angle 2d of the irradiated laser beam 2 may be changed.

Incidentally, excepting losses, manufacturing errors and the like in the first polarizing beam splitter 6, if the laser beam 2 with a polarized direction the same as the P-waves is irradiated, it all becomes the laser beam 7 and passes through, and if the laser beam 2 with a polarized direction the same as the S-waves is irradiated, it all becomes the laser beam 8 and is reflected.

To equally disperse the energy of the laser beam 7 and the laser beam 8, the laser beam 2 may be irradiated at a polarizing angle of 45 degrees to the P-waves and the S-waves.

When the laser beam 2 is amplified from the laser oscillator 1, since the polarizing angle 2c is determined by the optical configuration of the laser oscillator 1, it is not easy to change the polarizing angle. However, if the laser beam 2 is passed through the third polarizing beam splitter 15, since only the P-wave components pass through and the S-waves are reflected, by changing the angle of the polarizing beam splitter 15, it becomes possible to easily change the polarizing angle 2c of the laser beam 2. As described above, it becomes possible to stop, with the damper 25, the S-wave components of the laser beam 2 that are reflected by the third polarizing beam splitter 15.

When adjusting the polarizing angle by the third polarizing beam splitter 15, since the S-wave components are not passed through and are lost, to utilize the laser beam efficiently, the polarizing angle 2c of the laser beam 2 before irradiating the third polarizing beam splitter 15 (the polarizing angle when amplified by the laser oscillator 1) may be configured to be as close as possible to the polarizing angle 2d of the laser beam 2 after passing through the third polarizing beam splitter 15.

In cases where such a configuration is used, it is sufficient that the angle adjustment amount of the third polarizing beam splitter be enough to compensate for manufacturing errors and the like for each optical system member, and energy losses for these members are only a few percent.

The angle adjustment mechanism for the third polarizing beam splitter 15 is as illustrated in FIG. 4.

So as to be able to revolve with the optical axis of the laser beam 2 as center, the third polarizing beam splitter 15 is fixed to a bracket 21, and the second pulley 24 is fixed so as to revolve together with the third polarizing beam splitter 15.

Furthermore, the servo motor 20 to which the first pulley 23 is attached is also fixed to the bracket 21, and the second pulley 24 that is fixed to the third polarizing beam splitter 15 and the first pulley 23 that is fixed to the servo motor 20 are linked by the timing belt 22.

When the servo motor 20 revolves by means of a signal from a control device, which is not illustrated in the figure, power is transmitted to the third polarizing beam splitter 15 via the timing belt 22 and the angle of the third-polarizing beam splitter 15 is changed.

Further, it becomes possible to stop, with the damper 25, the S-wave components of the laser beam 2 that are reflected by the third polarizing beam splitter 15.

Here, when adjusting the polarizing direction angle by the third polarizing beam splitter 15, since the S-wave components are not passed through and are lost, to utilize the laser beam efficiently the irradiation may be done so as to have the polarizing angle 2c of the laser beam 2 before irradiating the third polarizing beam splitter 15 as close as possible to the polarizing angle 2d of the laser beam 2 after passing through the third polarizing beam splitter 15.

In order to irradiate the laser beam 2 at a correct polarizing angle onto the first polarizing beam splitter 6, the angle adjustment of the third polarizing beam splitter 15 has the role of fine-tuning the polarizing angle 2d.

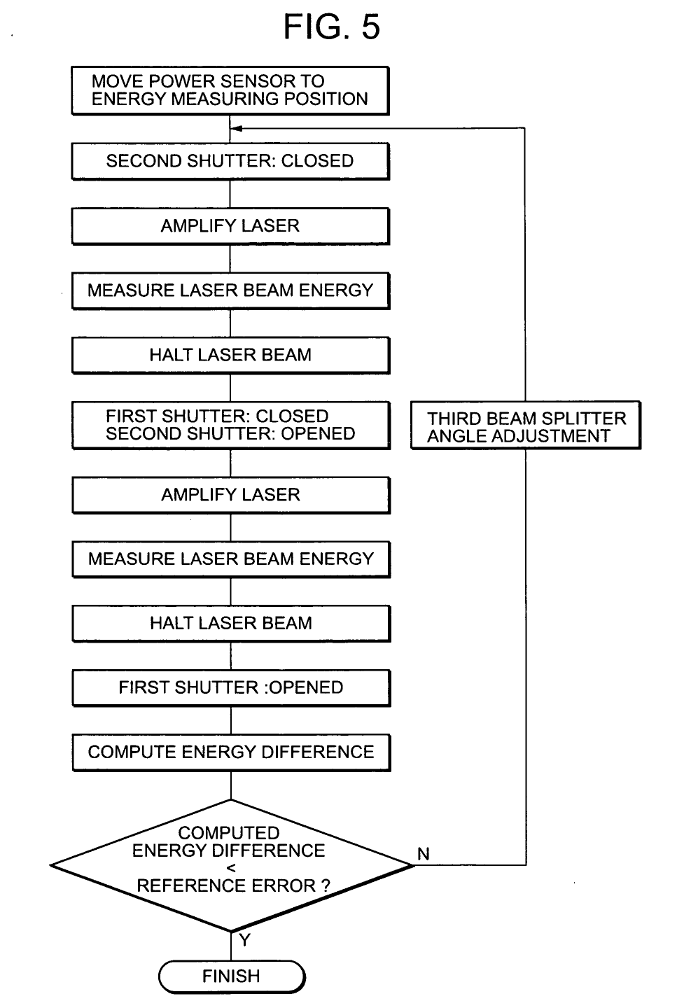

FIG. 5 illustrates control flow for automatic adjustment of the angle of the polarizing beam splitter for the polarizing angle adjustment, so as to extract the two laser beams with desired energy proportions in this embodiment of the invention.

The explanation uses FIG. 3 and FIG. 5, and, for convenience, cases are described where the two energy quantities are equal.

Furthermore, even in cases where the energy of the two laser beams has different proportions, if the initial configuration is changed, implementation is possible using the same method.

An energy variation tolerance between the laser beam 7 and the laser beam 8 is decided and input to the control device, which is not illustrated in the figure, and an automatic angle adjustment program for the third polarizing beam splitter 15 is executed.

Firstly, the power sensor 16 that is fixed to the XY-table 14 is moved to a position where the light receptor of the power sensor 16 can receive laser beams emitted from the fθ lens 10.

After that, the second shutter 18 is closed, and a laser beam is amplified from the laser oscillator 1.

By closing the second shutter 18, the laser beam 8 is shut off by that member, the laser beam 7 only is emitted from the fθ lens 10, and the energy of the laser beam 7 is measured by the power sensor 16.

After measuring the energy, the laser amplification is stopped once, the first shutter 17 is closed, the second shutter 18 is opened, and the laser is amplified again.

This time, by closing the first shutter 17, the laser beam 7 is shut off by that member, the laser beam 8 only is emitted from the fθ lens 10, and the energy of the laser beam 8 is measured by the power sensor 16. After measuring the energy, the amplification of the laser beam is halted and the second shutter 18 is opened.

The energy difference of the two laser beams measured in the control device is computed and is compared with the tolerance value initially input.

If within the tolerance value range, the program finishes; if outside the tolerance value range, the angle of the third polarizing beam splitter 15 is adjusted, energy measurement of the two laser beams is again carried out, and the operations described are repeated until within the tolerance value range.

The amount of angle adjustment in the third polarizing beam splitter 15 is dependent upon the polarized direction 2c of the incident laser beam 2 and the attaching angle of the first polarizing beam splitter 6; if the polarizing angle 2d of the laser beam 2 after passing through the third polarizing beam splitter 15 is changed by roughly a few degrees from the polarizing angle 2c of the laser beam 2 before irradiating the third polarizing beam splitter 15, the ability to adjust an energy difference of approximately 7% for each 1 degree in the third polarizing beam splitter 15 can theoretically be obtained.

In this way, the relationship between the adjustment angle of the third polarizing beam splitter 15 and the energy difference between the two laser beams can theoretically be obtained from the polarizing angle 2c of the incident laser beam 2 and the attaching angle of the first polarizing beam splitter 6; thus, though the following is dependant on the tolerance value of the energy difference, if the tolerance value is of the order of 5%, if the above described adjustment loop is performed twice, the adjustment (program) finishes, and an easy adjustment in a short time is possible.

According to this embodiment, in the laser machining apparatus wherein one laser beam is dispersed into the two laser beams by the polarizing beam splitter for dispersion, and by independently scanning the two laser beams: it is possible to simultaneously implement machining at two positions, the polarizing beam splitter for adjusting the polarized angle being installed ahead of the dispersing polarizing beam splitter in order to change the polarizing angle of the laser beams with respect to the P-waves (the waves passed through) and the S-waves (the reflected waves) at the dispersing polarizing beam splitter, and a mechanism being installed that can perform angle adjustment at the polarizing beam splitter for polarizing angle adjustment; by enabling angle adjustment by a command from the control device, the energy balance of the dispersed laser beams can easily be adjusted; and by making the energy uniform, machining performance is made stable, initial setup time is shortened and it is possible to realize stable production.

Furthermore, the sensor is installed for measuring the energy of the laser beams, the energy of the two laser beams is measured, and by being able to automatically adjust the angle of the polarizing beam splitter for polarized angle adjustment in order to extract the two laser beams with desired energy proportions, initial setup time can be even further shortened, and additionally, by facilitating the adjustment, a skilled operator becomes unnecessary, and stable machining can be realized.

### Embodiment 3

In the above described Embodiment 2, in order to minimize the quality difference in the two dispersed laser beams, by making the light path lengths the same, the beam spot diameters also become the same; however, since the two dispersed laser beams have different light paths up to where they are scanned and guided to the same fθ lens so that each of them irradiates different positions, due to variations in manufacturing accuracy of optical members passed through, there are changes in focusing characteristics and the focal position of the two laser beams may differ, resulting in differences in machining quality (hole diameter, hole depth, roundness and the like).

Further, within the optical members after dispersion, galvano-mirrors are made light-weight in order to improve drive speed of the galvano-scanners, and optical elements that make the polarizing beam splitters reflect or pass the laser beams are fixed to a mounting member and integrated, and as a result of these characteristics it is difficult to manufacture while restraining variations, and this has been a cause of the focal positions of the laser beams being different.

Thus, the present embodiment outlines a laser machining apparatus in which a focal position adjustment means is added in order to further improve machining quality, even in cases where the focusing points of the two laser beams are different.

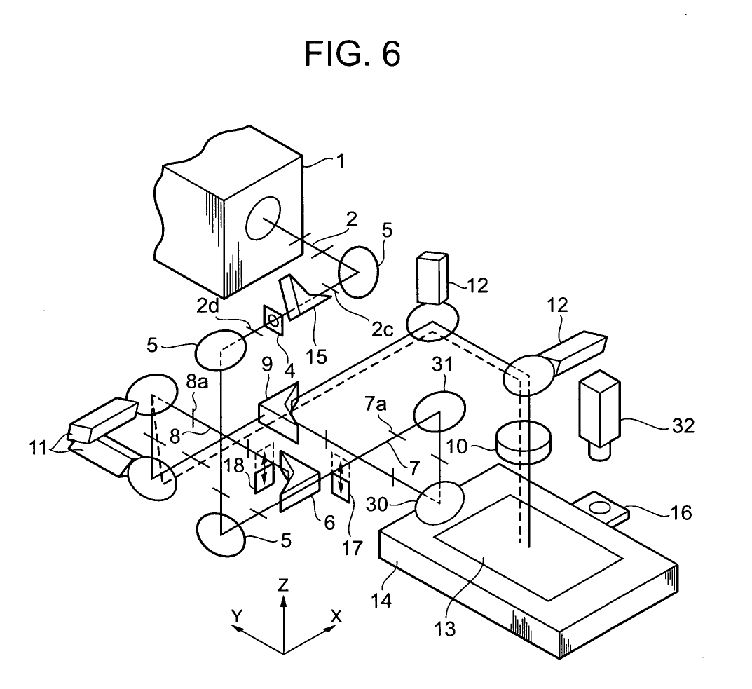

FIG. 6 is a schematic configuration diagram illustrating the laser machining apparatus in accordance with this embodiment of the invention.

In the figure, reference numeral 30 denotes a first deformable mirror, being a first focusing-position change means for the laser beam 7, reference numeral 31 denotes a second deformable mirror, being a second focusing-position change means for the laser beam 7, reference numeral 32 denotes a CCD camera being an image pickup element for measuring the hole diameter, hole position and the like, of holes drilled by the laser beams.

Other similar reference numerals are the same as in FIG. 1 illustrating Embodiment 1, and are omitted.

Further, the third polarizing beam splitter in this embodiment is for energy adjustment, and it has another function besides usage for focal position adjustment in this embodiment. That is, in this embodiment, as in FIG. 6, by adding to the system of FIG. 1, the energy adjustment can additionally be carried out more assuredly, as against Embodiment 1 described above.

The laser beam 7 that passes through the first polarizing beam splitter 6 is guided, via the first deformable mirror 30 and the second deformable mirror 31 to the second polarizing beam splitter 9.

Meanwhile, the laser beam 8 that is reflected by the first beam splitter 6, after being scanned bi-axially by the first galvano-scanner 11, is guided to the second polarizing beam splitter 9.

Then, after the laser beams 7 and 8 are scanned bi-axially by the second galvano-scanner 12, they are irradiated onto the workpiece 13 by the fθ lens.

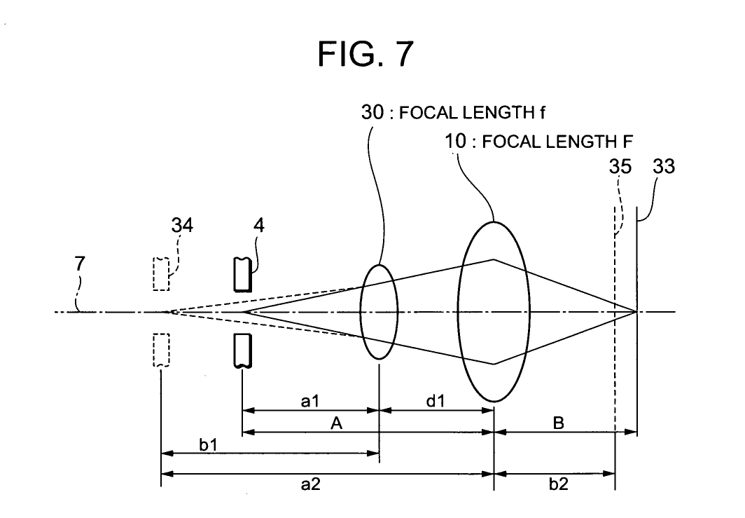

Regarding the laser machining apparatus according to this embodiment of the invention, FIG. 7 is a schematic diagram illustrating change in focal position of the laser beam 7 in cases, for example, where the deformable mirror 30 is changed into a concave shape.

In the figure, reference numeral 4 denotes the mask, reference numeral 10 denotes the fθ lens (with focal length F), reference numeral 30 denotes the deformable mirror (with focal length f), reference numeral 33 denotes the focal position when an image of the mask 4 is transferred by the fθ lens 10, reference numeral 34 denotes a virtual position of the mask that is regarded as having moved, by the effect of the deformable mirror 30, reference numeral 35 denotes the focal position when the image of the mask 34 is transferred by the fθ lens 10.

In cases where the image formed by the mask 4 is transferred to the focal position 33 by the fθ lens 10 that has a focal length F, when the deformable mirror has a flat surface, the relationship between the focal length F of the fθ lens 10, the distance A from the mask 4 to the fθ lens 10, and a work distance B, being the distance from the fθ lens 10 to the focal position 33, can be expressed by the following equation.
1/A+1/B=1/F (1)

Here, by the effect of the deformable mirror 30, disposed along the light path, the mask 4 can be considered to be at the virtual position 34.

Where the distance b1 between the mask virtual position 34 and the deformable mirror 30 is considered to have the same value as the focal length f of the deformable mirror 30, equation (2) can be expressed, and by changing the shape of equation (2), bi can be obtained from equation (3).
1/a1+1/b1=1/f (2)
b1=−f·a1/(a1−f) (3)
The right side of this equation (3) is multiplied by −1 because the focal length f of the deformable mirror 30 is extremely large, and if equation (3) is solved, the value of b1 would be negative.

Next, when an image at the virtual position 34 of the mask is considered to have been transferred, by the fθ lens 10 with focal length F, onto the workpiece, the relationship between the distance a2 from the virtual position 34 of the mask to the fθ lens 10, and a work distance b2, being the distance between the fθ lens 10 and the focal position 35 after changes, can be expressed by equation (4), and the distance a2 from the virtual position 34 of the mask to the fθ lens 10 can be expressed by equation (5).
1/a2+1/b2=1/F (4)
a2=b1+d1 (5)
Thus, equation (6) can be obtained from equation (4) and equation (5).
b2=F·(b1+d1)/((b1+d1)−F) (6)
Since the three items a1, d1 and F are elements decided and obtained in advance when the laser paths are being designed, in equation (3) if the focal lengths f of the first deformable mirror 30 and the second deformable mirror 31 are decided, b1 can be obtained, and it is possible to obtain the work distance b2 of the laser beam 7 from equation (6).

By reverse-calculating these equations, it can be made possible to freely change the work distance b2 of the laser beam 7.

The distance from the mask 4 to the deformable mirrors 30 and 31=a1

The distance from the deformable mirrors 30 and 31 to the lens 10=d1

The focal length of the fθ lens=F

For example, when a1=1500 mm, d1=185 mm and F=100 mm, the work distance, B, of the laser beam 8 is 106.309 mm; at this time, if it is desired to make the work distance of the laser beam 7 shorter, by 0.1 mm, than that of the laser beam 8, the focal length can be calculated as b1=1525.54 mm, and the deformable mirrors 30 and 31 may be adjusted to realize this focal length.

Furthermore, in cases where the deformable mirrors are convex shaped, it is possible to obtain the same effect, and in such cases, it is possible to make the focal position of the laser beam 7 to operate in a direction in which it becomes longer.

In this embodiment of the invention, by changing the focal length f of the first deformable mirror 30 or the second deformable mirror 31, it is possible to independently change the focal position of the laser beam 7 with respect to the focal position for the laser beam 8 when the image of the mask 4 is transferred by the fθ lens 10; in cases where there is a difference in the focal positions of the laser beam 8 and the laser beam 7 due to variations in the optical members each of the laser beams pass through, with the focal position of the laser beam 8 as reference, by measuring the discrepancy amount in the focal position of the laser beam 7, the focal lengths of the deformable mirrors 30 and 31 are decided, and it is possible to minimize the difference between the focal positions of the laser beam 8 and the laser beam 7.

Here, in order to change the focal position of the laser beam 7, there are a method wherein the focal length of one of either the first deformable mirror 30 only, or the second deformable mirror 31 only, is adjusted, and a method wherein the focal lengths of both the first deformable mirror 30 and the second deformable mirror 31 are adjusted, and the focal lengths of the two deformable mirrors are adjusted so that the focal position change amount is the same as in the case where the focal position is changed by one or other of the deformable mirrors, and in either of these cases the focal position of the laser beam 7 can be changed so that it is possible to obtain an equivalent result.

In this embodiment of the invention, in cases where the two deformable mirrors are in mutually staggered positions, for example, in cases where the deformable mirror 30 is disposed in a normal line direction perpendicular to a plane including X-direction and Z-direction light paths and at −45 degrees to a light path angle of 90 degrees to the X-direction and the Z-direction, and the deformable mirror 31 is disposed in a normal line direction perpendicular to a plane including Z-direction and Y-direction light paths and at 45 degrees to a light path angle of 90 degrees to the Z-direction and the Y-direction, by combining the effects of the focal lengths of the two deformable mirrors and changing the focal position of the laser beam 7, and by making the focal lengths of the two deformable mirrors equivalent, there is an effect of lessening aberrations occurring due to inserting the deformable mirrors along the light paths, and it is possible to realize machining of more stable quality.

### Embodiment 4

Thus, the present embodiment outlines a laser machining apparatus in which a means to change a light path length is added, as a focal position adjustment means for cases where the focal positions are different for the two laser beams that are dispersed.

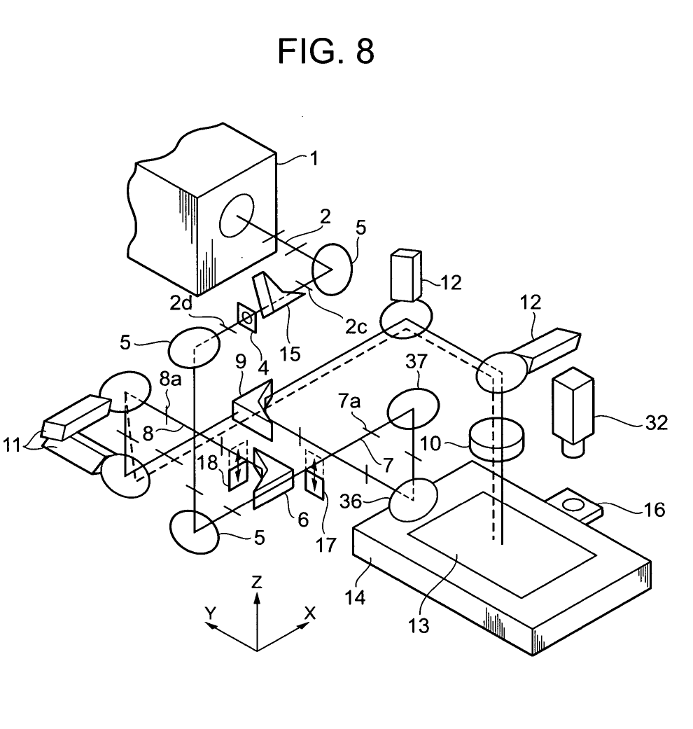

FIG. 8 is a schematic configuration diagram illustrating the laser machining apparatus in accordance with this embodiment of the invention.

In the figure, reference numeral 37 denotes a first moveable mirror, being one member of the focal position changing means, and having a configuration such that parallel movement in the X-axis is possible, and angle changes are possible with an axis parallel to the Y-axis as supporting point, reference numeral 36 denotes a second moveable mirror, being one member of the focal position changing means, and having a configuration such that angle adjustment is possible without changing the light path leading to the second polarizing beam splitter 9 even if the incident angle is changed due to movement of the first moveable mirror 37.

Other similar reference numerals are the same as in FIG. 6 illustrating Embodiment 3, and explanations are omitted.

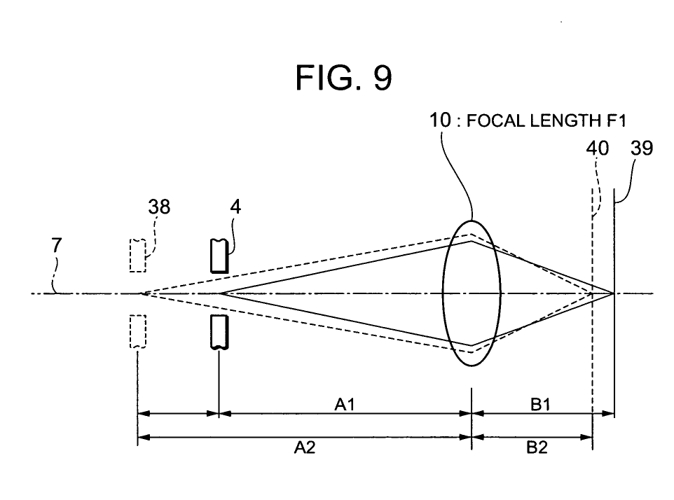

For a laser machining apparatus in accordance with this embodiment of the invention, FIG. 9 is a schematic diagram illustrating change in the focal position of the laser beam 7 in cases, for example, where the position and angle of the first moveable mirror 36 and the second moveable mirror 37 are changed, and by extending the light path length between the first moveable mirror 36 and the second moveable mirror 37, the light path length of the laser beam 7 between the mask 4 and the fθ lens 10 is extended.

In the figure, reference numeral 4 denotes the mask, reference numeral 10 denotes the fθ lens with focal length F1, reference numeral 38 denotes the mask position considered to have moved due to the light path length extension with the lens 10 as reference, reference numeral 39 denotes a focal position to which an image of the mask 4 is transferred by the fθ lens 10, reference numeral 40 denotes a focal position to which an image of the mask 38 is transferred by the fθ lens.

In FIG. 9, similarly to Embodiment 3, the relation between the focal length F1 of the fθ lens 10, the distance A1 from the mask 4 to the fθ lens 10, and the work distance B1, being the distance from the fθ lens 10 to the focal position 39, can be represented by the following equation.
1/A1+1/B1=1/F1 (7)

Further, the relation between the distance, A2, from the mask position 38 to the fθ lens 10 after movement due to the light path length extension between the first moveable mirror 37 and the second moveable mirror 36, and the work distance B2, being the distance from the fθ lens 10 to the focal position 40, can be represented by the following equation.
1/A2+1/B2=1/F1 (8)
Here, since the focal length F1 of the fθ lens 10 is fixed, in cases where A2 is larger than A1, due to the light path extension between the mask 4 and the fθ lens 10, B2 is smaller than B1. That is, by the work distance changing from B1 to B2, it is understood that the focal position 39 can be moved to 40.

For example, when A1=1,685 mm and F=100 mm, the work distance of the laser beam 8 is given by B 1=106.3091 mm; at this time, if it is desired to make the work distance of the laser beam 7 shorter by 0.05 mm than that of the laser beam 8, in order to make B2=106.2591 mm, A1=1697.67 mm, and the light path length between the first moveable mirror 37 and the second moveable mirror 36 may be extended by 12.67 mm.

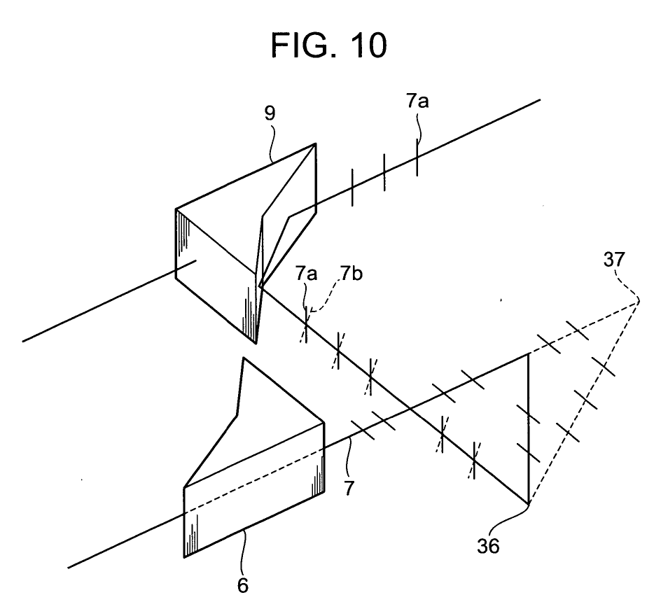

For Embodiment 4 of this invention, FIG. 10 illustrates the disposition of the first moveable mirror 37 and the second moveable mirror 36 and the change in the polarized direction 7a of the laser beam 7, for cases where the light path length between the first moveable mirror 37 and the second-moveable mirror 36 is changed and the focal position of the laser beam 7 is moved.

In the figure, reference numeral 7a denotes the polarized direction of the laser beam 7 incident on the second polarizing beam splitter 9 when the light path length is not changed, and reference numeral 7b denotes the polarized direction of the laser beam 7 when the light path length between the first moveable mirror 37 and the second moveable mirror 36 is changed.

When the light path length is not changed, since the polarized direction 7a of the laser beam 7 matches with the S-wave components of the second polarizing beam splitter 9, all the energy held by the laser beam 7 is reflected in the second polarizing beam splitter 9 and is used as machining energy.

However, when the light path length is changed, due to the fact that the polarized direction 7b of the laser beam 7 irradiates at an angle with respect to the S-wave components of the second polarizing beam splitter 9, a portion of the energy held by the laser beam 7 is passed through the second polarizing beam splitter 9 as P-wave components, with the result that losses in the energy of the laser beam 7 occur in these members.

For example, the laser beam is guided so that the polarized direction of the laser beam that passes through the third polarizing beam splitter 15 is at an angle of 45 degrees to the S-waves and P-waves at the first polarizing beam splitter 6; even if the energy of the laser beam 8 that is reflected by the first polarizing beam splitter 6 is equal to that of the laser beam 7 that is passed through, energy is lost in the laser beam 7 at the second polarizing beam splitter 9, so that the energy of the laser beam 8 and that of the laser beam 7 cannot be made equal.

In such cases, polarizing angle adjustment is carried out at the third polarizing beam splitter 15, and in order to cancel out the laser beam 7 energy losses at the second polarizing beam splitter 9, the polarizing angle of the laser beam incident to the first polarizing beam splitter 6 may be adjusted.

For example, since, by increasing the P-wave components that pass through the first polarizing beam splitter 6 it is possible to increase the energy of the laser beam 7, in order to incline the polarizing angle of the laser beam incident on the first polarizing beam splitter 6, from an angle of 45 degrees to the mutually perpendicular P-waves and S-waves, to be a direction closer to the P-waves, polarizing angle adjustment may be done at the third polarizing beam splitter 15.

In this embodiment of the invention, by changing the light path length between the first moveable mirror 37 and the second moveable mirror 36, it is possible to independently change the focal position of the laser beam 7 with respect to the focal position of the laser beam 8 when the image of the mask 4 is transferred by the f) lens 10; even in cases where a change occurs in the focal positions due to variations in the optical members each of the laser beam 8 and the laser beam 7 pass through, with the focal position of the laser beam 8 as reference, by measuring the discrepancy amount in the focal position of the laser beam 7, the distance between the first moveable mirror 37 and the second moveable mirror 36 is decided, and it is possible to minimize the difference between the focal positions of the laser beam 8 and the laser beam 7.

Further, it is possible to compensate for the energy loss that occurs in the laser beam 7 at this time by implementing polarizing angle adjustment using the third polarizing beam splitter 15, and the energy of the laser beam 8 and the laser beam 7 can be made equal.

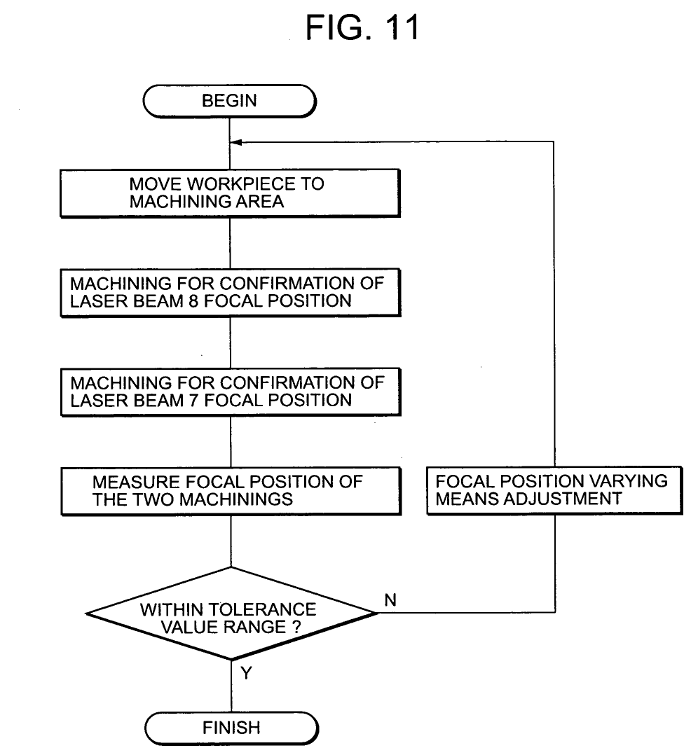

FIG. 11 is used to describe control flow when automatically adjusting the light path length by means of the focal lengths of the two deformable mirrors or by the two moveable mirrors, in order to adjust the difference in the focal positions of the two laser beams.

Firstly, a workpiece 13 (for example, an acrylic plate) for adjustment, pre-installed on the XY-stage 14, is moved into the machining area of the f) lens 10.

The first shutter 18 is opened, the second shutter 17 is closed, and, by machining for confirming focal position on the workpiece with the laser beam 8 only, for example, by means of a driver device not illustrated in the figure, by moving in the Z-direction the optical path members between the first polarizing beam splitter 6 and the fθ lens 10, in addition to the complete CCD camera 32 set, by moving in the direction of the Z-axis the distance between the workpiece 13 and the fθ lens 10, and by moving the XY-stage 14, machining is implemented at different positions by means of different work distances.

After that, the first shutter 17 is opened, the second shutter 18 is closed, and with the laser beam 7 only, machining is implemented for confirmation of focal position on the workpiece.

After carrying out the machining, by moving the XY-stage 14, the diameter and the circularity of the hole drilled by the laser beams 8 and 7 are measured with the CCD camera 32.

With regard to the control device, from the measured drilled hole diameter and circularity the focal positions of the two laser beams are determined, and if the difference between the focal positions is within the tolerance value range, the program is finished; however, if outside the tolerance values, from the difference in the focal positions of the two laser beams 8 and 7, the focal lengths of the variable geometry mirrors or the adjustment quantity of the light path length by the moveable mirrors is computed, machining for confirming the focal positions of the two laser beams is again carried out and these operations are repeated until the tolerance value range is reached.

Here, in cases where the light path length is adjusted by the moveable mirrors, at the time when the adjustment of the focal positions is finished, adjustment by the third polarizing beam splitter 15 may be done so that the energy of the two laser beams is equal.

By carrying out this type of focal position adjustment regularly—for example, at initial setup, when the apparatus is being started up and the like—the hole quality of the two laser beams can be constantly maintained at a higher accuracy, and since a skilled operator is not necessary, it is possible to implement stable machining.

According to this invention, by minimizing differences in the energy and quality of the dispersed laser beams so that the light path lengths of each are the same, it is possible to make the beam spot diameters approximately the same and to inexpensively improve production quality.

1-11. (canceled)

12. A laser machining apparatus for machining a workpiece, wherein a laser emitted from an oscillator is dispersed into a first laser beam that is passed through a first polarizing beam splitter and is reflected, via a mirror, by a second polarizing beam splitter, and into a second laser beam that is reflected by the first polarizing beam splitter, scanned bi-axially by a first galvano-scanner, and passed through the second polarizing beam splitter, scanning by a second galvano-scanner being carried out, the laser machining apparatus comprising:
a third polarizing beam splitter, capable of polarizing-angle adjustment, disposed in front of the first polarizing beam splitter.

13. The laser machining apparatus as recited in claim 12 further comprising:
a sensor for measuring energy of the laser beams, wherein the energy of the two laser beams is measured, and angle adjustment is performed by a third polarizing beam splitter, in order to extract the two laser beams with desired energy proportions.

14. The laser machining apparatus as recited in claim 12 wherein:
focal positions of the two laser beams are measured, based on a measuring means for measuring laser-beam focal position, and adjustment is carried out by a deformable mirror, so that the difference between the focal positions of the two laser beams is below a desired reference.

15. The laser machining apparatus as recited in claim 14, wherein:
the deformable mirror, which is curved, is disposed along the light path of one of the two laser beams after the laser light has been dispersed, and the deformable mirror is provided for adjusting focal positions thereof by changing the focal length of the curved deformable mirror.

16. The laser machining apparatus as recited in claim 14, wherein:
a mirror that can change a light path length for adjusting focal position by changing light path length of a light path, along the light path of one of the two laser beams after the laser beams have been dispersed, is provided as the deformable mirror.

17. The laser machining apparatus as recited in claim 16, wherein:
the light path length is changed by making variable the attachment angle or position of reflection mirrors, disposed along the light path of the laser beam, for reflecting the laser beams.

18. A laser machining apparatus for machining a workpiece, wherein a laser emitted from an oscillator is dispersed into a first laser beam that is passed through a first polarizing beam splitter and is reflected, via a mirror, by a second polarizing beam splitter, and a second laser beam that is reflected by the first polarizing beam splitter, scanned bi-axially by a first galvano-scanner, and passed through the second polarizing beam splitter, scanning by a second galvano-scanner being carried out, characterized in that:
focal positions of the two laser beams are measured, based on a measuring means for measuring the focal positions of the laser beams, and adjustment is carried out by a deformable mirror so that the difference between the focal positions of the two laser beams is below a desired reference.

19. The laser machining apparatus as recited in claim 18, wherein:
the deformable mirror, which is curved, is disposed along the light path of one of the two laser beams after the laser beams have been dispersed, and the deformable mirror is provided for adjusting focal positions thereof by changing the focal length of the curved deformable mirror.

20. The laser machining apparatus as recited in claim 18, wherein:
a mirror that can change a light path length for adjusting focal position by changing light path length of a light path, along the light path of one of the two laser beams after the laser beams have been dispersed, is provided as the deformable mirror.

21. The laser machining apparatus as recited in claim 18, wherein:
light path length is changed by making variable the attachment angle or position of reflection mirrors, disposed along the light path of a laser beam, for reflecting the laser beams.

22. The laser machining apparatus as recited in claim 12, wherein:
reflective faces of the first and the second polarizing beam splitter are disposed facing each other, to form light paths in which the light path lengths of each of the dispersed laser beams are each the same.

23. The laser machining apparatus as recited in claim 18, wherein:
reflective faces of the first and the second polarizing beam splitter are disposed facing each other, to form light paths in which the light path lengths of each of the dispersed laser beams are each the same.
